(19) United States
(12) Patent Application Publication
(10) Pub. No.: US 2025/0273812 A1
(43) Pub. Date: Aug. 28, 2025

(54) BATTERY PACK AND VEHICLE

(71) Applicant: LG ENERGY SOLUTION, LTD., Seoul (KR)

(72) Inventors: Ju Hwan SHIN, Daejeon (KR); Hyoung Suk LEE, Daejeon (KR); Jae Hyun LEE, Daejeon (KR); Byung Do JANG, Daejeon (KR)

(21) Appl. No.: 18/847,217

(22) PCT Filed: Oct. 20, 2023
(86) PCT No.: PCT/KR2023/016330

§ 371 Date: May 15, 2025

(30) Foreign Application Priority Data
Oct. 21, 2022 (KR) 10-2022-0136062

(51) Int. Cl. H01M 50/383; H01M 50/24; H01M 50/249; H01M 50/271; H01M 50/291; H01M 50/342

(52) U.S. Cl. CPC H01M 50/383; H01M 50/24; H01M 50/249; H01M 50/271; H01M 50/291; H01M 50/3425; H01M 2220/20

(57) ABSTRACT

The present technology relates to a battery pack accommodating a battery module, the battery pack including a pack case providing a space in which the battery module is seated; a top cover coupled to the pack case to cover the top of the battery module seated in the pack case; and a screen cover interposed between the pack case and the top cover, the screen cover including a through hole configured to expose a top of the battery module to the outside.

### CROSS-REFERENCE TO RELATED APPLICATIONS

The present application is a National Phase entry pursuant to 35 U.S.C. § 371 of International Application No. PCT/KR2023/016330, filed on Oct. 20, 2023, and claims the benefit of and priority to Korean Patent Application No. 10-2022-0136062, filed in the Korean Intellectual Property Office on Oct. 21, 2022, the disclosures of both of which are incorporated herein by reference in their entirety for all purposes as if fully set forth herein.

### TECHNICAL FIELD

The present disclosure relates to a battery pack, wherewhen a flame with high temperature gases occurs in any one of a plurality of battery modules accommodated therein, a screen cover is applied which is capable of extinguishing the flame so that the flame is not directly exposed to the outside.

### BACKGROUND

One of the most important problems with lithium secondary batteries is ensuring safety, as there is a risk of explosion and fire, etc. due to heat generation. The internal temperature of the secondary battery increases rapidly due to heat generation, and the rapid increase in temperature can cause a thermal runaway phenomenon, which can lead to an explosion of the secondary battery, and can also spread to adjacent secondary batteries, causing great damage to the battery pack.

In order to eliminate such risks, control means are provided to monitor and control the voltage, current, etc. of a battery pack, or means are provided to extinguish a fire from the outside when a fire occurs in a battery pack, but a problem can arise in that such means alone cannot provide an initial rapid and active response to a fire occurring in a battery pack.

FIG. 1 is a perspective view of a conventional battery pack 10, including a pack case and a battery module M accommodated in an inner space of the pack case.

In a battery pack 10 of the structure described above, when thermal runaway occurs in any of the battery modules M accommodated therein, flames generated by the battery modules M may be discharged to the outside through the top. Most battery packs 10 may further include a top cover etc. that is coupled to the pack case to cover the top of the battery modules M, but there is a significant risk that the top cover may also be damaged by exposure to the flame.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

Accordingly, aspects of the present disclosure were conceived at least in part to solve the above problems, with an object of providing a battery pack capable of preventing the flame generated during thermal runaway from being directly exposed to the outside, even if a thermal runaway phenomenon occurs in the battery module accommodated therein.

Other objects and advantages of the present disclosure will be understood from the following description and will become more apparent with reference to embodiments of the present disclosure. Also, it will be readily apparent that the objects and advantages of the present disclosure may be realized by the means and combinations thereof disclosed in the patent claims.

According to the present disclosure, a battery pack accommodating a battery module includes: a pack case providing a space in which the battery module is seated; a top cover coupled to the pack case to cover a top of the battery module seated in the pack case; and a screen cover interposed between the pack case and the top cover, the screen cover comprising a through hole configured to expose a top of the battery module to the outside.

According to certain aspects, the screen cover may include a plurality of through holes, and the through holes may be formed at predetermined intervals spaced along a transverse axis and a vertical axis of the screen cover.

According to certain aspects, the through holes may be formed in at least one of a circular and a polygon shape.

According to certain aspects, the pack case includes: a base plate supporting the bottom of the battery module; a main separation wall coupled across a center of the base plate; and a side wall coupled along an edge of the base plate; wherein the pack case includes a pair of module areas divided by the main separation wall, and the screen cover may be coupled to the pack case to cover at least one of the module areas among the pair of module areas.

According to certain aspects, the pack case includes: a base plate supporting the bottom of the battery module; a main separation wall coupled across a center of the base plate; a side wall coupled along an edge of the base plate; and a sub separation wall coupled at both ends with the main separation wall and the side wall, respectively, and coupled to the base plate at predetermined intervals spaced along a length direction of the main separation wall; wherein the pack case includes a plurality of module areas divided and formed by the main separation wall and the sub separation wall, and the screen cover may be coupled to the pack case to cover at least one of the module areas among the plurality of module areas.

According to certain aspects, the sides of the screen cover comprise laterally projecting protrusion parts and groove parts formed between the protrusion parts, and a pair of screen covers disposed adjacent to each other may be coupled by engaging the protrusion parts and groove parts with each other.

According to certain aspects, the screen cover may include a flame-resistant material.

According to certain aspects, the screen cover may further include a rupture member coupled to an inner circumferential surface of the through hole to block the through hole.

According to certain aspects, the rupture member may include a thermoplastic material, and the through hole may be opened as the rupture member is melted by the high temperature heat generated in the module area.

According to certain aspects, the rupture member is coupled to the through hole is to be destroyed when a certain pressure is applied, and the through hole may be opened by the destruction of the rupture member by high pressure gas generated in the module area.

According to certain aspects, a plurality of screen covers may be stacked and interposed between the top cover and the pack case.

According to certain aspects, the through holes included in any one of the plurality of screen covers may be disposed in the same position as the through holes included in other screen covers.

According to certain aspects, any one of the plurality of screen covers may be disposed in a position where the through hole is obstructed by another screen cover.

According to certain aspects, the through hole may be formed in a slit form.

According to certain aspects, a vehicle may include the battery pack of any of the above embodiments.

According to the present disclosure, even if thermal runaway occurs in the battery module accommodated inside, the stability of a battery pack can be improved by preventing a phenomenon in which a flame generated simultaneously with the thermal runaway extends to the outside.

### BRIEF DESCRIPTION OF THE DRAWINGS

FIG. 1 is a perspective view of a conventional battery pack.

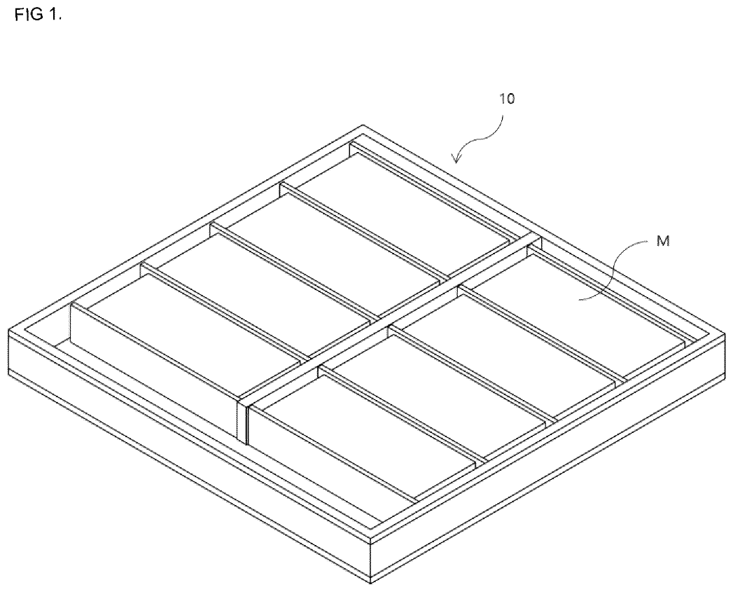

FIG. 2 is a perspective view of a battery pack according to a first embodiment of the present disclosure.

FIG. 3 is a top view of the battery pack of FIG. 2, without the top cover.

FIG. 4 is a cross-sectional view of a portion of the battery pack of FIG. 3 between the sub separation walls.

FIG. 5 illustrates a first modified example of the screen cover.

FIG. 6 illustrates a second modified example of the screen cover.

FIG. 7 illustrates a third modified example of the screen cover.

FIG. 8 illustrates a fourth modified example of the screen cover.

FIG. 9 is a perspective view of a battery pack according to a second embodiment of the present disclosure.

FIG. 10 is a top view of the battery pack of FIG. 9 with the top cover removed.

FIG. 11 is a perspective view of a battery pack according to a third embodiment of the present disclosure.

FIG. 12 is a top view of the battery pack of FIG. 11 with the top cover removed.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Accordingly, it is to be understood that the embodiments described herein, and the configurations illustrated in the drawings are only the most preferred embodiments of the present disclosure and do not represent all of the technical ideas of the present disclosure, so it should be understood that other equivalents and modifications could be made thereto without departing from the spirit and scope of the disclosure.

In addition, detailed descriptions of well-known functions and constructions may be omitted for clarity and conciseness.

The embodiments of the present disclosure are provided to illustrate the present disclosure more completely to those of ordinary skill in the art, and the shapes and sizes of the components in the drawings may be exaggerated, omitted, or shown schematically for clarity. Therefore, the size or proportions of each component are not necessarily indicative of actual size or proportions.

The present disclosure relates to a battery pack, where when a flame with high temperature gases occurs in any one of a plurality of battery modules accommodated therein, a screen cover is applied which is capable of extinguishing the flame so that the flame is not directly exposed to the outside.

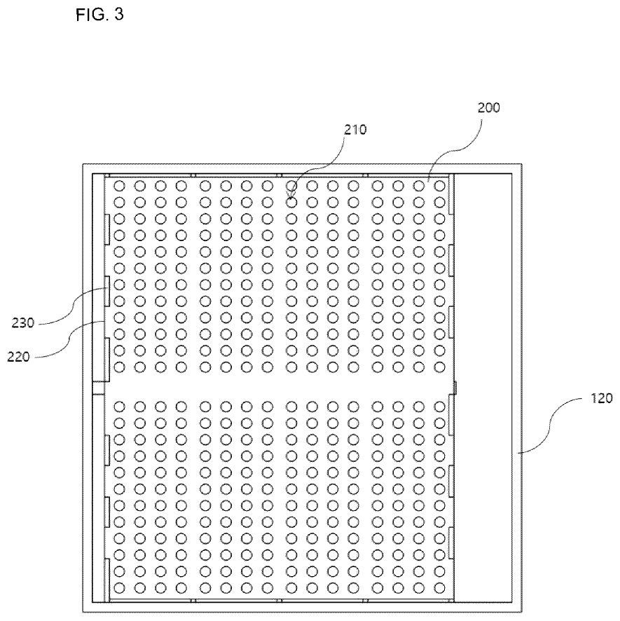

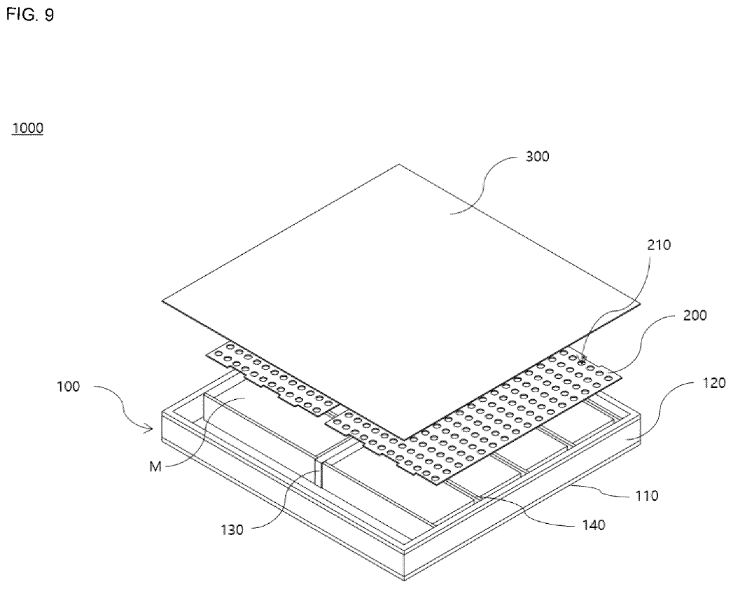

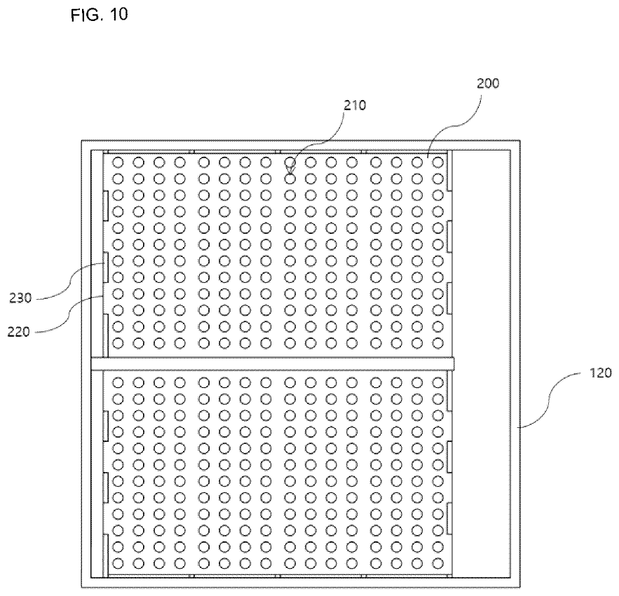

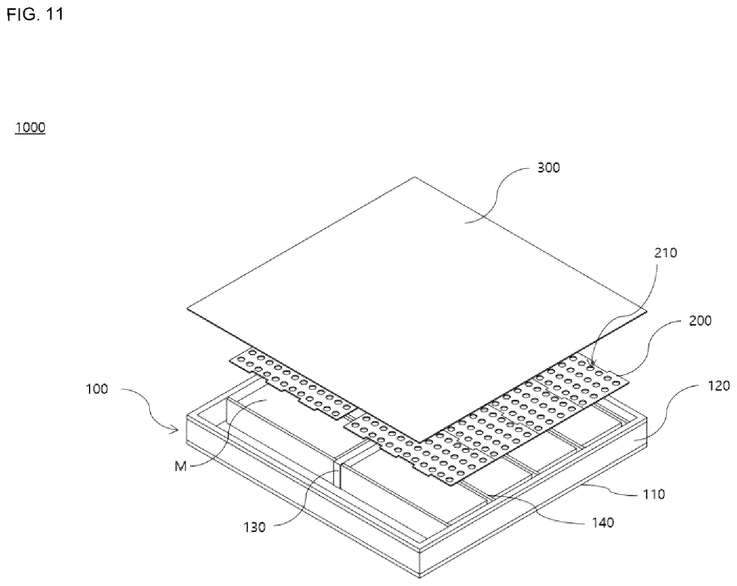

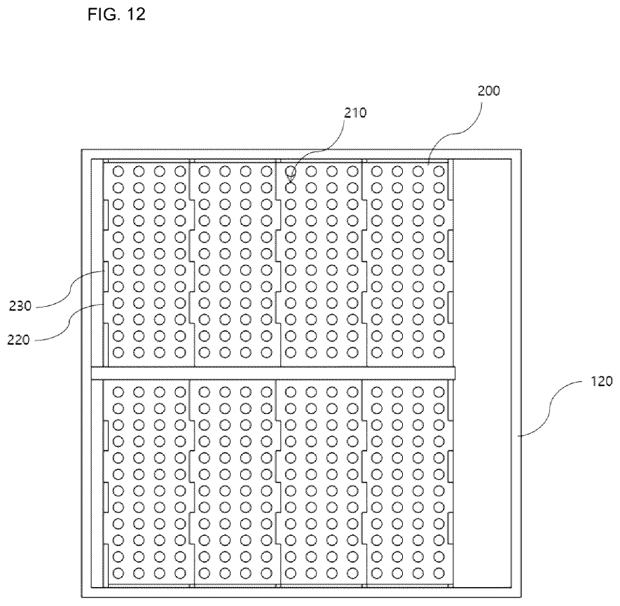

FIG. 3 to FIG. 6 relate to a battery pack according to a first embodiment of the present disclosure, FIG. 9 to FIG. 10 relate to a battery pack according to a second embodiment of the present disclosure, and FIG. 11 to FIG. 12 relate to a battery pack according to a third embodiment of the present disclosure.

Hereinafter, the battery pack of the present disclosure according to each embodiment will be described with reference to the accompanying drawings.

### First Embodiment

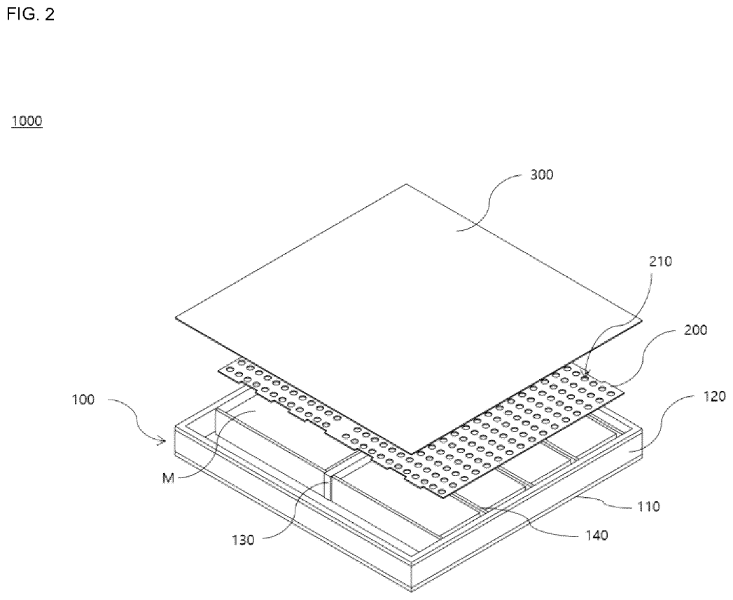

FIG. 2 is a perspective view of a battery pack 1000 according to a first embodiment of the present disclosure.

The battery pack 1000 according to aspects of the present disclosure as shown in FIG. 2 includes a pack case 100, a top cover 300, and a screen cover 200.

According to certain aspects, the pack case 100 serves to provide a space in which the battery module M is seated and encloses and protects the bottom and sides of the battery module M seated therein.

According to certain aspects, he pack case 100 comprises a base plate 110 supporting the bottom of the battery module M, and side wall 120 coupled along an edge of the base plate 110 to support the sides of the battery module M.

According to certain aspects, he pack case 100 may further comprise a main separation wall 130 coupled across the center of the base plate 110.

According to certain aspects, the main separation wall 130 divides the internal space of the pack case 100 in half and separates into two large spaces.

Within the main separation wall 130, various measuring wires, busbars, and the like may be inserted.

According to certain aspects, the pack case 100 includes a pair of module areas divided by the main separation wall 130, wherein each module area may contain one or more battery modules M.

The pack case 100 may further comprise a sub separation wall 140, which is coupled at both ends to the main separation wall 130 and the side wall 120, respectively.

According to certain aspects, the sub separation wall 140 serves to re-divide the module area formed on one side of the main separation wall 130, separating each battery module M from the other.

According to certain aspects, a plurality of sub separation walls 140 are spaced apart at predetermined intervals along the length direction of the main separation wall 130 on both sides of the main separation wall 130 and are coupled to the base plate 110.

According to certain aspects, the top cover 300 is coupled to the pack case 100, and serves to cover the top of the battery module M seated in the pack case 100 to protect from external shocks etc. More specifically, according to certain aspects, the top cover 300 is coupled to the side wall 120 included in the pack case 100 to enclose and protect all of the top of the battery module M therein.

According to certain aspects, the screen cover 200 is interposed between the pack case 100 and the top cover 300 and covers the top of each battery module M at the bottom of the top cover 300.

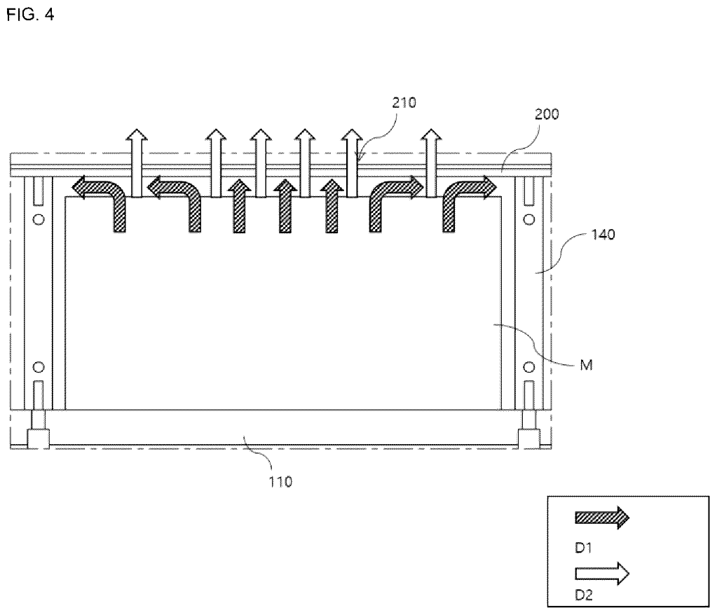

FIG. 3 is a top view of the battery pack 1000 without the top cover 300, and FIG. 4 is a cross-sectional view of a part of the battery pack 1000 of FIG. 3 between the sub separation walls 140.

According to certain aspects, the screen cover 200, as shown in FIGS. 2 and 3 includes a through hole 210 that is configured to to expose the top of the battery module M to the outside. According to certain aspects, the screen cover 200 including the through hole 210 is coupled to the pack case 100 to cover the top of the plurality of battery modules M seated in the pack case 100.

According to certain aspects, the screen cover 200 of the present disclosure serves to prevent flames from spreading to the outside when a fire occurs in the plurality of battery modules M accommodated therein.

Referring to FIG. 4, according to certain aspects, the flame is blocked by the screen cover 200 and cannot spread to the outside, but only moves in the direction D1 along the bottom surface of the screen cover 200, and the gas moves in the direction D2 through the through hole 210 and is discharged to the outside.

According to certain aspects, the through hole 210 formed in the screen cover 200, as shown in FIG. 4 may serve as a passageway for high temperature gases generated with a fire to discharge but may prevent flames from escaping. Thus, the screen cover 200 may prevent fire from spreading to the entire battery pack 1000 by preventing flames from directly contacting the top cover 300.

According to certain aspects, the screen cover 200 may be directly exposed to the flame generated by the battery module M in thermal runaway condition, and should be able to withstand high temperatures of heat in the exposed state. Therefore, the screen cover 200 preferably comprises a material that is resistant to high temperatures of heat and flame. In other words, the screen cover 200 preferably comprises a flame-resistant material.

According to certain aspects, the screen cover 200 may be coupled to the side wall 120 of the pack case 100, the same as the top cover 300, and/or may be coupled to the main separation wall 130 and sub separation wall 140.

According to certain aspects, the sides of the screen cover 200 may comprise protrusion part 220 projecting sideways along the perimeter and groove part 230 formed between the protrusion part 220. In this case, the top of the side wall 120 of the pack case 100 may be structured to engage the protrusion part 220 and groove part 230 of the screen cover 200, and the screen cover 200 may be secured to the pack case 100 with the protrusion part 220 and groove part 230 engaging and coupled to the side wall 120.

According to certain aspects, the size and number of the through holes 210 may be designed to vary according to the size and number of the battery module M accommodated in the battery pack 1000.

However, according to certain aspects, the through holes 210 are preferably limited to a size such that flames generated by the battery modules M are not exposed to the outside through the through hole 210.

According to certain aspects, the screen cover 200 may include a plurality of through holes 210, and the plurality of through holes 210 may be formed at predetermined intervals spaced apart.

According to certain aspects, the through holes 210, as shown in FIGS. 2 and 3. are formed along a transverse axis and a vertical axis of the screen cover 200.

When a fire occurs in the battery module M accommodated in the battery pack 1000 of the present disclosure, according to certain aspects the flame caused by the fire spreads upwards where the top cover 300 is located. However, the battery pack 1000 according to aspects of the present disclosure is capable of preventing the flame from spreading upward through a screen cover 200 interposed between the top cover 300 and the battery module M. That is, the screen cover 200 prevents the flame from spreading upward. Furthermore, the screen cover 200 can selectively discharge high temperature gases through the through hole 210.

The battery pack 1000 of the present disclosure may also include a plurality of screen covers 200. In other words, a plurality of stacked screen covers 200 may not only prevent flames from the bottom, but also delay the transfer of high temperature heat to the top cover 300.

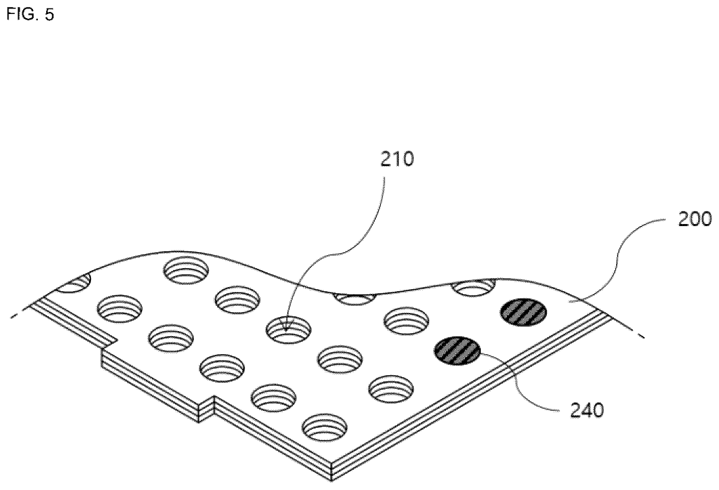

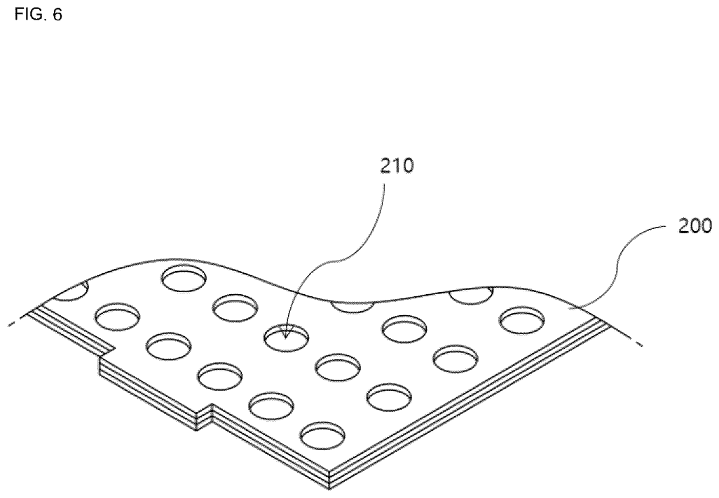

FIG. 5 illustrates a first modified example of the screen cover 200, in which a plurality of screen covers 200 are stacked, and FIG. 6 illustrates a second modified example of the screen cover 200, in which a plurality of screen covers 200 are stacked.

FIG. 5 illustrates a plurality of screen covers 200 stacked together with through holes 210 disposed in the same location, so that the through holes 210 allow for the discharge of gases but prevent the discharge of flames.

FIG. 6 shows a stacked form of a plurality of screen covers 200 in which the through holes 210 are disposed in non-uniform positions, that is, the through holes 210 included in any one of the plurality of screen covers 200 are disposed in positions that are obstructed by other screen covers 200.

According to certain aspects, the screen cover 200 stacked in the form shown in FIG. 6 has the advantage that the discharge of gas may not be smooth, but the discharge of flame can be effectively prevented.

The through hole 210 may be circular shape as shown, but is not limited thereto, and the through hole 210 may be formed in a circular shape as shown, or may be formed in a polygonal shape.

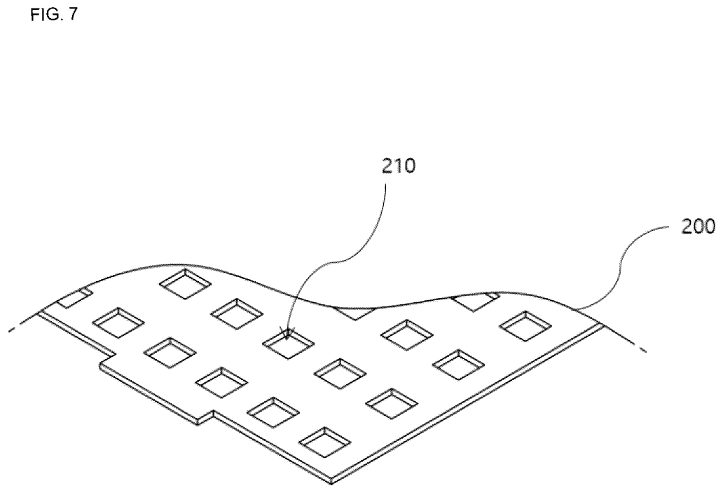

FIG. 7 is a third modified example of the screen cover 200, in which a rectangular through hole 210 is formed.

The through hole 210 may also be formed in a point shape, such as circular or polygonal shape, or may be formed in the slit shape.

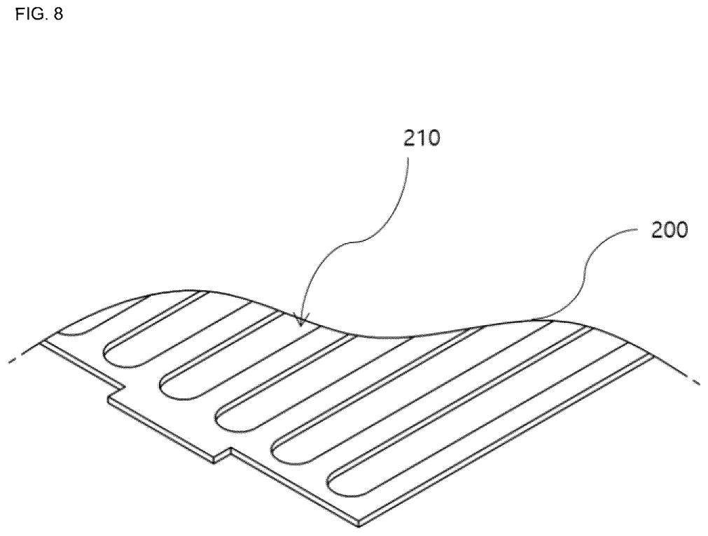

FIG. 8 shows a fourth modified example of the screen cover 200, in which a slit-shaped through hole 210 is formed. The through hole 210 in the form shown in FIG. 8 extends along a transverse or vertical axis of the screen cover 200. The slit-shaped through hole 210 as described above has a larger opening area, but it may be possible to prevent discharge of flames by adjusting the width of the through hole 210.

According to certain aspects, the screen cover 200 may further comprise a rupture member coupled to an inner circumferential surface of the through hole 210 to block the through hole 210.

According to certain aspects, the rupture members may be ruptured by high temperatures of heat or gases under high pressure generated by thermal runaway of the battery module M.

Specifically, the rupture member, which is usually coupled to the through hole 210 and serves to ensure that the battery module M accommodated therein is sealed, may be melted by the high temperature heat generated by the thermal runaway of the battery module M. In other words, the through hole 210 may be opened as the rupture member is melted by the high temperature heat generated in the module area. In this case, the rupture member may comprise a thermoplastic material that is readily melted by high temperatures of heat.

Alternatively, the rupture member may be destroyed by a high-pressure gas generated by the thermal runaway of the battery module M. That is, the through hole 210 may be opened by the destruction of the rupture member by a high-pressure gas generated in the module area.

### Second Embodiment

FIG. 9 is a perspective view of a battery pack 1000 according to a second embodiment of the present disclosure, and FIG. 10 is a plan view of the battery pack 1000 of FIG. 9 with the top cover 300 removed.

The battery pack 1000 of the present disclosure includes a pack case 100, a top cover 300, and a screen cover 200, as shown in FIG. 9 above.

The screen cover 200 is coupled to the pack case 100 to cover at least one of a pair of module areas divided by the main separation wall 130. In other words, the battery pack 1000 according to a second embodiment of the present disclosure is characterized in that the screen cover 200 can be coupled in pairs to either side of the main separation wall 130.

As described above, the screen covers 200 separated by the main separation wall 130 are not connected to each other, so heat transfer through conduction between them is not possible. Therefore, even if a thermal runaway occurs in the battery module M accommodated on one side of the main separation wall 130, and the screen cover 200 covering the top of the battery module M is heated by the high temperature, the heat is not transferred to the other screen cover 200 disposed on the other side of the main separation wall 130.

### Third Embodiment

FIG. 11 is a perspective view of a battery pack 1000 according to a third embodiment of the present disclosure, and FIG. 12 is a plan view of the battery pack 1000 of FIG. 11 with the top cover 300 removed.

The battery pack 1000 of the present disclosure includes a pack case 100, a top cover 300, and a screen cover 200, as shown in FIG. 11.

The screen cover 200 is coupled to the pack case 100 to cover at least one of a plurality of module areas formed by the main separation wall 130 and sub separation wall 140. In other words, the battery pack 1000 according to a third embodiment of the present disclosure, wherein the screen cover 200 is coupled to cover a module area between a pair of sub separation wall 140 disposed at predetermined intervals on either side of the main separation wall 130.

Each of the module areas may be covered by one screen cover 200, wherein a pair of screen covers 200 disposed adjacent to each other may be engaged by the protrusion part 220 and the groove part 230 engaging each other.

When a single screen cover 200 is coupled to a module area as described above, it is possible to selectively position the screen cover 200 in only those areas where it is needed, thereby reducing the amount of screen cover 200 used to further improve safety while simultaneously improving the energy efficiency of the battery pack 1000.

Although the disclosure is shown and described in connection with particular embodiments, it will be readily apparent to those of ordinary skill in the art that various modifications and variations are possible without departing from the spirit and scope of the disclosure shown in the appended claims.

### DESCRIPTION OF REFERENCE NUMERALS

10: (prior art) battery pack
1000: battery pack
100: pack case
110: base plate
120: side wall
130: main separation wall
140: sub separation wall
200: screen cover
210: through hole
220: protrusion part
230: groove part
240: rupture member
300: top cover
M: battery module
D1: flame movement
D2: gas movement

1. A battery pack accommodating a battery module, the battery pack comprising:
a pack case providing a space in which the battery module is seated;
a top cover coupled to the pack case to cover the top of the battery module seated in the pack case; and
a screen cover interposed between the pack case and the top cover,
and wherein the screen cover comprises a through hole that is configured to expose a top of the battery module to the outside.

2. The battery pack of claim 1, wherein the screen cover comprises a plurality of through holes, and the plurality of through holes are formed at predetermined intervals spaced along a transverse axis and a vertical axis of the screen cover.

3. The battery pack of claim 1, wherein the screen cover comprises a plurality of through holes that are formed in at least one of a circular and a polygon shape.

4. The battery pack of claim 1, wherein the pack case comprises:
a base plate supporting the bottom of the battery module;
a main separation wall coupled across a center of the base plate; and
side walls coupled along an edge of the base plate;
wherein the pack case comprises a pair of module areas divided by the main separation wall, and the screen cover is coupled to the pack case to cover at least one of the module areas among the pair of module areas.

5. The battery pack of claim 1, wherein the pack case comprises:
a base plate supporting the bottom of the battery module;
a main separation wall coupled across a center of the base plate;
a side wall coupled along an edge of the base plate; and
a sub separation wall coupled at both ends with the main separation wall and the side wall, respectively, and coupled to the base plate at predetermined intervals spaced along a length direction of the main separation wall,
wherein the pack case comprises a plurality of module areas divided and formed by the main separation wall and the sub separation wall, and the screen cover is coupled to the pack case to cover at least one of the module areas among the plurality of module areas.

6. The battery pack of claim 5, wherein the sides of the screen cover comprise laterally projecting protrusion parts and groove parts formed between the protrusion parts,
and a pair of screen covers disposed adjacent to each other is coupled by engaging the protrusion parts and groove parts with each other.

7. The battery pack of claim 1, wherein the screen cover comprises a flame-resistant material.

8. The battery pack of claim 1, wherein the screen cover further comprises a rupture member coupled to an inner circumferential surface of the through hole to block the through hole.

9. The battery pack of claim 8, wherein the rupture member comprises a thermoplastic material, and the through hole is opened as the rupture member is melted by the high temperature heat generated in a module area of the pack case.

10. The battery pack of claim 8, wherein the rupture member is coupled to the through hole to be destroyed when a certain pressure is applied, and the through hole is opened by the destruction of the rupture member by high pressure gas generated in a module area of the pack case.

11. The battery pack of claim 1, wherein a plurality of screen covers are stacked and interposed between the top cover and the pack case.

12. The battery pack of claim 11, wherein through holes included in any one of the plurality of screen covers are disposed in the same position as through holes included in other screen covers.

13. The battery pack of claim 11, wherein any one of the plurality of screen covers is disposed in a position where the through hole is obstructed by another screen cover.

14. The battery pack of claim 1, wherein the through hole is formed in a slit form.

15. A vehicle comprising the battery pack of claim 1.
